(19) United States
(12) Patent Application Publication
(10) Pub. No.: US 2015/0117439 A1
(43) Pub. Date: Apr. 30, 2015

(54) SYSTEMS AND METHODS FOR CONTROLLING TELEPHONY COMMUNICATIONS

(71) Applicant: Vonage Network, LLC, Holmdel, NJ (US)

(72) Inventor: TZAHI EFRATI, GIVATAIM (IL)

(73) Assignee: Vonage Network, LLC, Holmdel, NJ (US)

(21) Appl. No.: 14/061,856

(22) Filed: Oct. 24, 2013

(51) Int. Cl. H04L 29/06

(52) U.S. Cl. CPC H04L 65/1079
USPC 370/352

(57) ABSTRACT

A telephony communication system prevents an incoming telephony communication directed to a user from being completed if the user is not authorized to communicate with the calling party. Likewise, a telephony system prevents a user from completing an outgoing telephony communication directed to a called party if the user the user is not authorized to communicate with the called party. The telephony communication system also electronically monitors a telephony communication between first and second parties and censors portions of the telephony communication to terminates the telephony communication if predetermined keywords appear in the communication.

### BACKGROUND OF THE INVENTION

The invention is related to telephony communications systems. More specifically, the invention is related to systems and methods for determining when to complete a requested telephony communication between a calling and a called party. The invention is also related to systems and methods for selectively censoring portions of a telephony communication or for terminating a telephony communication based on the content of the telephony communication.

There are several reasons why a party receiving an incoming telephone call might wish to refuse to answer the incoming call. For example, the incoming call may be from a telemarketer. Alternatively, the incoming call might be from a calling party with whom the called party does not wish to speak.

One way to pre-screen an incoming call is to review caller ID information for the incoming call to determine the telephone number and possibly the name or identity of the calling party. Some telephony systems can be configured to automatically block calls based on the caller ID information. This typically involves creating a “black list” of telephone numbers that are connected with undesirable parties, and then blocking all calls from those telephone numbers. Alternatively, such calls can be automatically routed to voice mail, or the telephony system can be configured to play a message to such callers, and then automatically disconnect the call.

Unfortunately, it is possible to spoof the telephone numbers and names that are included in the caller ID information that is delivered with an incoming call setup request. As a result, a telemarketer can periodically change the telephone number and/or name that is presented in the caller ID information shown to the called party. This makes it difficult or impossible to block the calls using a black list and automatic screening techniques. Thus it would be desirable to find other ways to identity the calling party for purposes of blocking undesirable calls, and/or for purposes of screening incoming calls.

Another problem with calls from telemarketers and people seeking to perpetrate fraudulent acts stems from the fact that a single telephone or telephone line in a residence or business often can be answered by many different individuals. For example, a telephone or telephone line in a residence might be answered by any of the family members who live in the residence, including young children. A young child that answers a call from a telemarketer, or a person seeking to perpetrate a fraudulent act, might be induced to reveal potentially damaging information. Although it is possible to block some such calls via the pre-screening and automatic blocking techniques discussed above, it is also possible for a calling party to spoof caller ID information in order to successfully complete such a call to a vulnerable young person. Thus, it would be desirable to terminate such calls, or conduct some level of censorship, if such a call is answered by a young person who might be particularly vulnerable.

In a similar fashion, if a young person has access to a telephone or telephone line in a residence, the young person may be able to send an outgoing call to an individual or business and provide information or request a service against the wishes of the young person's parent or guardian. Rather than blocking all such calls on a particular line to those individuals or businesses, it would be desirable to block only the young person from placing an outgoing call to those individuals or businesses.

### BRIEF DESCRIPTION OF THE DRAWINGS

FIG. 1 is a diagram of a communications environment including various elements which are associated with an Internet protocol (IP) telephony system in accordance with an embodiment of the invention;

FIG. 2 is a diagram of various elements of a processor that forms part of an IP telephony system or an IP telephony device according to an embodiment of the invention;

FIG. 3 is block diagram illustrating various elements of an IP telephony system according to an embodiment of the invention;

FIG. 4 is a block diagram of various elements of a telephony communication setup unit;

FIG. 5 is a block diagram of various elements of a telephony communication censoring unit;

FIG. 6 is flowchart illustrating steps of a method of that would be performed to determine whether to complete an outgoing telephony communication requested by a user;

FIG. 7 is a flowchart illustrating steps of a method of determining whether to complete an incoming telephony communication directed to a user.

FIG. 8 is a flowchart illustrating steps of a first method of determining an identity of a party to a telephony communication;

FIG. 9 is a flowchart illustrating steps of a second method of determining an identity of a party to a telephony communication; and

FIG. 10 is a flowchart illustrating steps of a method of censoring a telephony communication.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

In the following description, the terms VOIP system, VOIP telephony system, IP system and IP telephony system are all intended to refer to a system that connects callers and that delivers data, text or video communications using Internet protocol data communications.

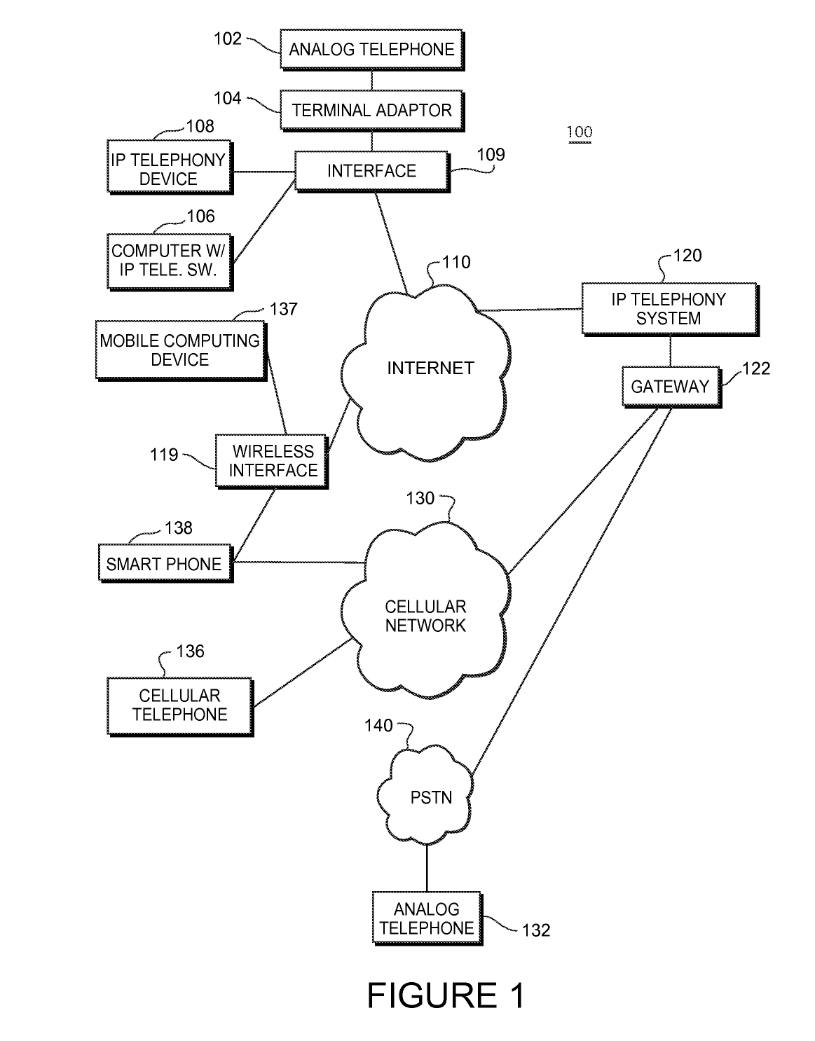

As illustrated in FIG. 1, a communications environment 100 is provided to facilitate IP based communications. An IP telephony system 120 enables connection of telephone calls between its own customers and other parties via data communications that pass over a data network. The data network is commonly the Internet 110, however, private data networks may form all or a portion of the data communication path. The IP telephony system 120 is connected to the Internet 110. In addition, the IP telephony system 120 is connected to a publicly switched telephone network (PSTN) 140 and/or a cellular network 130 via one or more gateways 122.

The gateway 122 allows users and devices that are connected to the PSTN 140 or cellular network 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110 via a data network interface 109. The IP telephone 108 could be connected to the data network interface 109 via a wired or wireless connection.

Alternatively, a customer could utilize a normal analog telephone 102 which is connected to the Internet 110 via a terminal adapter 104 and the data network interface 109. The terminal adapter 104 converts analog signals from the telephone 102 into data signals that pass over the Internet 110, and vice versa. Analog telephony devices include, but are not limited to, standard telephones and document imaging devices such as facsimile machines. A configuration using a terminal adapter 104 is common where the analog telephone 102 is located in a residence or business

In addition, a customer could utilize a computer that is running IP telephony software 106 to place and receive IP based telephone calls, and to access other IP telephony systems (not shown). Here again, the computer running IP telephony software would access the Internet 110 via the data network interface 109. In some instances, the IP telephony software could be assigned its own telephone number. In other instances, the IP telephony software could be associated with a telephone number that is also assigned to an IP telephone 108, or to a terminal adaptor 104 that is connected to an analog telephone 102.

In addition, a mobile computing device 137 which is running IP telephony software could also be used to place and receive telephone calls through the IP telephony system 120. The mobile computing device 137 accesses the Internet 110 via a wireless data network interface 119. The wireless data network interface could be a WiFi or WiMax router, or any other type of wireless data interface device capable of communicating wirelessly with the mobile computing device 137.

A third party using an analog telephone 132 which is connected to the PSTN 140 may call a customer of the IP telephony system 120. In this instance, the call is initially connected from the analog telephone 132 to the PSTN 140, and then from the PSTN 140, through the gateway 122 to the IP telephony system 120. The IP telephony system 120 then routes the call to the customer's IP telephony device. A third party using a cellular telephone 136 could also place a call to an IP telephony system 120 customer, and the connection would be established in a similar manner, although the first link would involve communications between the cellular telephone 136 and a cellular telephone network 130.

A smart phone 138 which includes cellular telephone capabilities could also be used to conduct telephony communications through both the IP telephony system 120 and the cellular network 130. For example, an IP telephony software application running on the smart phone 138 could communicate with the IP telephony system 120 via the Internet 110. The smart phone 138 could access the Internet 110 via the wireless data network interface device 119, or via a data channel of the cellular network 130. Of course, alternate embodiments could utilize any other form of wired or wireless communications paths to enable communications.

Users of the IP telephony system 120 are able to access the service from virtually any location where they can connect to the Internet 110. Thus, a customer could register with an IP telephony system in the U.S., and that customer could then use an IP telephone 108 located in a country outside the U.S. to access the services. Likewise, the customer could also utilize a computer outside the U.S. that is running IP telephony software to access the IP telephony system 120. Further, in some instances a user could place a telephone call with the analog telephone 132 or the cellular telephone 136 that is routed through the PSTN 130 or cellular network 140 to the IP telephony system 120 via the gateway 122. This would typically be accomplished by the user calling a local telephone number that is routed to the IP telephony system 120 via the gateway 122. Once connected to the IP telephony system 120, the user may then place an outgoing long distance call to anywhere in the world using the IP telephony system 120 network. Thus, the user is able place a long distance call using lower cost IP telephony service provided by the IP telephony system 120, rather than a higher cost service provided by the PSTN 130 or cellular network 130.

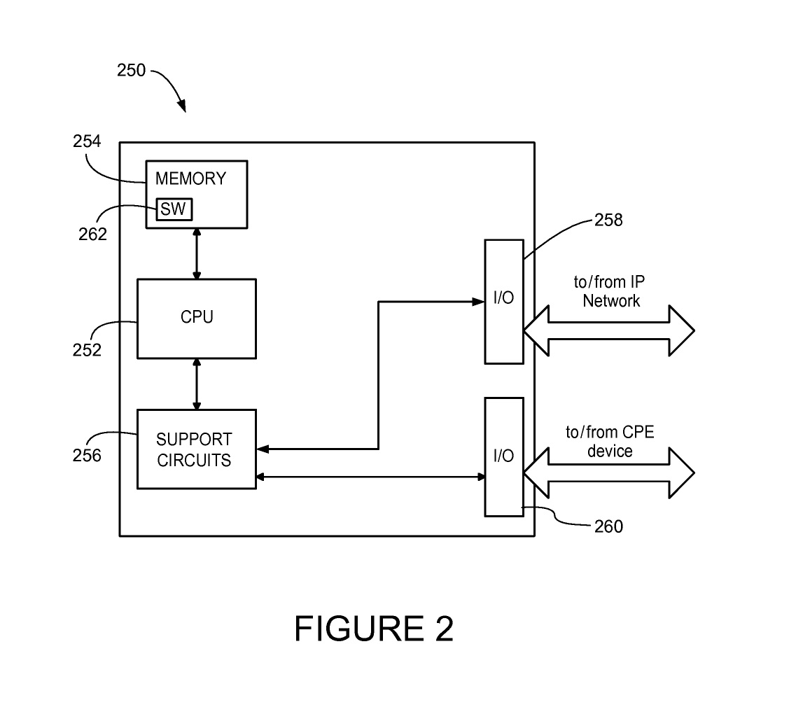

FIG. 2 illustrates elements of a computer processor 250 that can be used as part of the IP telephony system 120 or a telephony device to accomplish various functions. The IP telephony system 120 could include multiple processors 250 located at various locations in the system, along with their operating components and programming, each carrying out a specific or dedicated portion of the functions performed by the IP telephony system 120.

The processor 250 shown in FIG. 2 may be one of any form of a general purpose computer processor used in accessing an IP-based network, such as a corporate intranet, the Internet or the like. The processor 250 comprises a central processing unit (CPU) 252, a memory 254, and support circuits 256 for the CPU 252. The processor 250 also includes provisions 258/260 for connecting the processor 250 to customer equipment, to service provider equipment, to and IP network or gateways, as well as possibly one or more input/output devices (not shown) for accessing the processor and/or performing ancillary or administrative functions related thereto. The provisions 258/260 are shown as separate bus structures in FIG. 2; however, they may alternately be a single bus structure without degrading or otherwise changing the intended operability of the processor 250.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of the IP telephony system 120. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture.

References to an “IP telephony device” appear in both the foregoing and following descriptions. This term is used to refer to any type of device which is capable of interacting with an IP telephony system to conduct a communication. An IP telephony device could be an IP telephone, a computer running IP telephony software, a telephone adapter which is connected to an analog telephone, or some other type of device capable of communicating via data packets. An IP telephony device could also be a cellular telephone or a portable or tablet computing device that runs a software client that enables the device to act as an IP telephone. Thus, a single device might be capable of operating as both a cellular telephone and an IP telephony device.

Moreover, certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod touch™, which includes a speaker and a microphone. A software application loaded onto an Apple iPod touch™ can be run so that the Apple iPod touch™ can interact with an IP telephony system to conduct a telephone call.

The following description will also refer to telephony communications and telephony activity. These terms are intended to encompass all types of telephony communications, regardless of whether all or a portion of the communications are carried in an analog or digital format. Telephony communications could include audio or video telephone calls, facsimile transmissions, text messages, SMS messages, MMS messages, video messages, and all other types of telephony and data communications sent by or received by a user. These terms are also intended to encompass data communications that are conveyed through a PSTN or VOIP telephony system. In other words, these terms are intended to encompass any communications whatsoever, in any format, which traverse all or a portion of a communications network or telephony network.

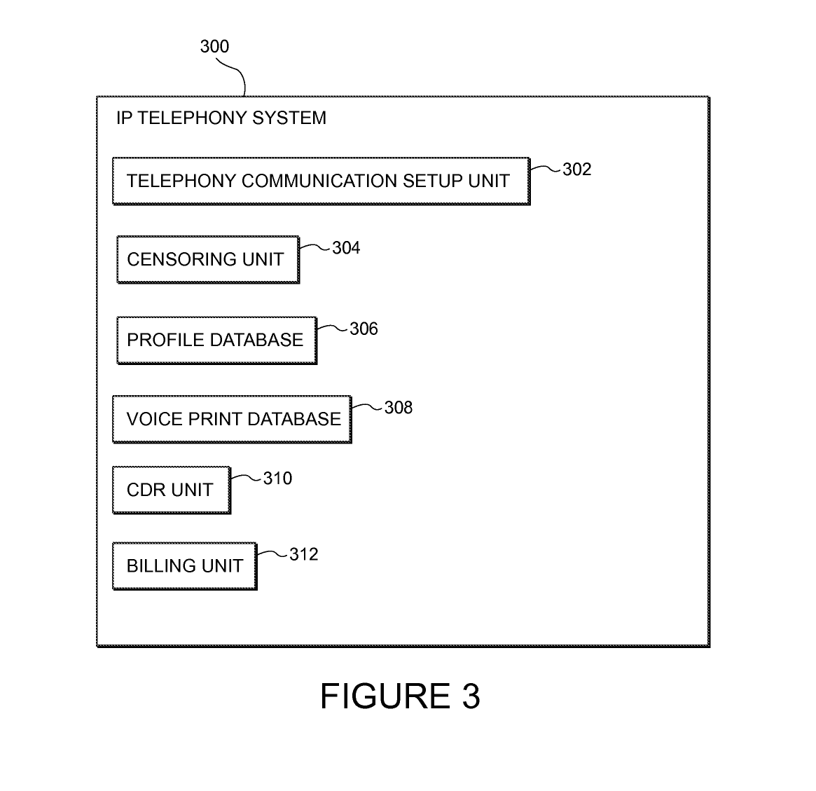

FIG. 3 illustrates selected elements of an IP telephony system 300 according to one embodiment of the invention. The IP telephony system 300 includes a telephony communication setup unit 302 which is responsible for setting up telephony communications. This can include both an outgoing telephony communication requested by a user of the IP telephony system 300, and incoming telephony communications where a third party has requested that a telephony communication be setup to a telephony device of an IP telephony system 300 user.

The IP telephony system 300 also includes a censoring unit 304 that can act to censor all or a portion of an ongoing telephony communication being conducted by a user of the IP telephony system 300. Details of the censoring unit 304 and how it operates are provided below.

The IP telephony system 300 further includes a profile database 306 that includes information about individual users of the IP telephony system 300. The profile database 306 can include information about whom a user of the IP telephony system 300 can communicate with. The profile database many also include information that indicates when a user's telephony communications should be censored or terminated, as will be discussed in detail below. This can include profile information that indicates what topics a user can and cannot discuss.

The IP telephony system 300 also includes a voice print database 308. The voice print database 308 includes one or more voice prints for individual users of the IP telephony system 300. A user could have a single voice print, or multiple voice prints. If multiple voice prints for a user are stored in the voice print database 308, each voice print could correspond to information captured via a different telephony device that the system user commonly uses to obtain telephony services from the IP telephony system 300. Each voice print could be obtained by having a user speak a common word or phrase, or possibly the user's own name. Alternatively, voice prints could be captured in a different fashion. The voice prints could be encoded and/or represented in many different ways, as is known to those skilled in the art. Also, a voice print, or voice prints, for a user could be recorded against a user account associated with a user, or against one or more identifiers for the telephony devices commonly operated by a user. Details about how voice prints in the voice print database 308 are used are provided below.

The IP telephony system also includes a call detail record (CDR) unit that creates and stores call detail records for individual telephony communications. A billing unit 312 utilizes information recorded by the CDR unit 310 to bill users for the telephony services provided by the IP telephony system 300.

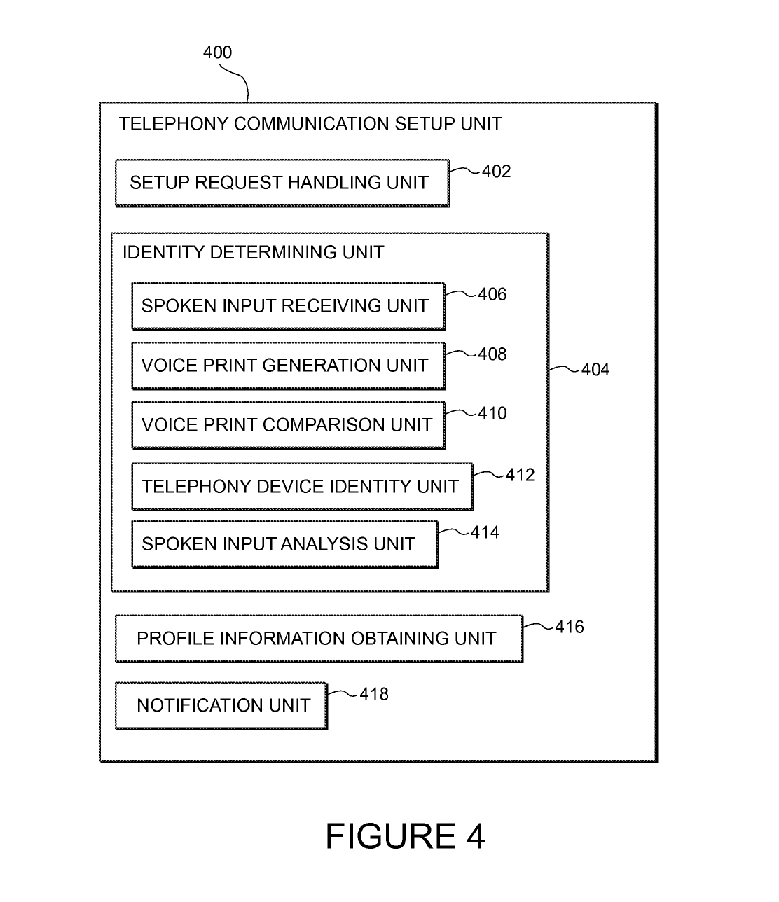

FIG. 4 illustrates selected elements of a telephony communication setup unit 400. In some instances, the telephony communication setup unit 400 illustrated in FIG. 4 would correspond to the telephony communication setup unit 302 of the IP telephony system 300 illustrated in FIG. 3. The telephony communication setup unit 400 could be resident on one or more servers maintained by an IP telephony system. Alternatively, all or a portion of the elements of the telephony communication setup unit 400 could be embodied by a software application that is loaded and running on a user's telephony device. In some embodiments, elements of the telephony communication setup unit may be split between servers of an IP telephony system, and software located on a user's telephony device.

The telephony communication setup unit 400 includes a setup request handling unit 402 that receives requests to setup a telephony communication. As mentioned above, a telephony communication could be an audio or video telephone call, an SMS or MMS message, as well as other forms of communications. A request to setup a telephony communication could come from a user of the IP telephony system 300 who is seeking to setup a telephony communication to another system user or to a party reachable via a separate telephony system. A request to setup a telephony communication also could come from a party who is a user of a separate telephony system, and who is seeking to setup a telephony communication with a user of the IP telephony system 300. The setup request handling unit 402 determines whether or not to setup the requested telephony communication with the assistance of an identity determining unit 404 and a profile information obtaining unit 416, and acts accordingly, as is discussed in detail below.

The identity determining unit 404 determines an identity of a calling party or a called party to a telephony communication. The identity determining unit 404 includes a spoken input receiving unit 406, a voice print generation unit 408 and a voice print comparison unit 410. These elements work together, as will be explained in detail below, to identify a party to the telephony communication via a voice print analysis.

The identity determining unit 404 also includes a telephony device identity unit 412. The telephony device identity unit 412 determines an identifier that is associated with a telephony device used by a party to a telephony communication. This could be a telephone number assigned to the telephony device. Alternatively, this could be an identification number associated with a telephony device, such as an International Mobile Subscriber Identity (IMSI) number that is assigned to most cellular telephones. The identifier could also be an identifier that has been assigned by an IP telephony system to an IP telephony device or to an IP telephony software application resident on a computing device. In still other instances, the identifier could be an Internet protocol address used by an IP telephony device, or some other identifier. Once the identifier of a telephony device is known, the identity of the party making use of the telephony device is determined or inferred from this information. Details about how the telephony device identification unit 412 operates to obtain a telephony device identifier and then identify the user of the telephony device are provided below.

The identity determining unit 404 also includes a spoken input analysis unit 414. The spoken input analysis unit 414 analyzes spoken input from a calling or called party using speech recognition techniques. Basically, the spoken input analysis unit 414 creates a transcript of spoken input provided by one or both parties to a telephony communication. This transcript can be compared to known scripts used by various telemarketers to determine if there is a match. If so, the party is identified as a known telemarketer. A transcript of all or a portion of spoken audio input also may be compared to keywords in an attempt to identify the party as belonging to a class or set of individuals. If the party can be identified in that fashion, the identity is used by the setup request handling unit 402 to determine whether to complete a requested telephony communication.

The telephony communication setup unit 400 also includes a profile information obtaining unit 416 that obtains information about a party to a telephony communication from a profile database 306 of an IP telephony system 300, as illustrated in FIG. 3. The information obtained from the user profile database 306 is used by the setup request handling unit 402 to determine whether or not to complete a requested telephony communication.

The telephony communication setup unit 400 further includes a notification unit 418 that is configured to send communications to an account administrator. Such communications could be in the form of e-mail or text messages. In alternate embodiments, the communication could be audio messages that are delivered to an account administrator's telephone or voice mail. For example, whenever the setup request handling unit 402 determines that a requested telephony communication should not be setup, the notification unit 418 may send a communication to the account administrator to inform the administrator that an attempted communication was refused. The communication could include details about the party that was attempting to setup the communication, and the reasons why it was refused.

In some embodiments, the notification unit 418 may be configured to send communication to the account administrator that indicates that the setup request handling unit 402 has tentatively decided to refuse to setup a telephony communication. The communication may ask the account administrator if the telephony communication should be refused, or if the administrator would like to authorize the setup of the communication. The notification unit would then receive input from the administrator and inform the setup request handling unit whether or not to proceed with setup of the telephony communication.

In some embodiments, when the setup request handling unit 402 tentatively determines that a communication setup request should be refused, the party requesting the telephony communication could cause the notification unit 418 to send a query to the account administrator asking the account administrator to override the tentative refusal decision of the setup request handling unit 402. The notification unit 418 would then receive input from the account administrator, and inform the setup request handling unit whether or not to setup the telephony communication.

Although many different elements of the telephony communication setup unit 400 are discussed above, in individual embodiments, fewer than all of the elements discussed above could be provided. Also, in some embodiments, additional elements that are not discussed above could be provided.

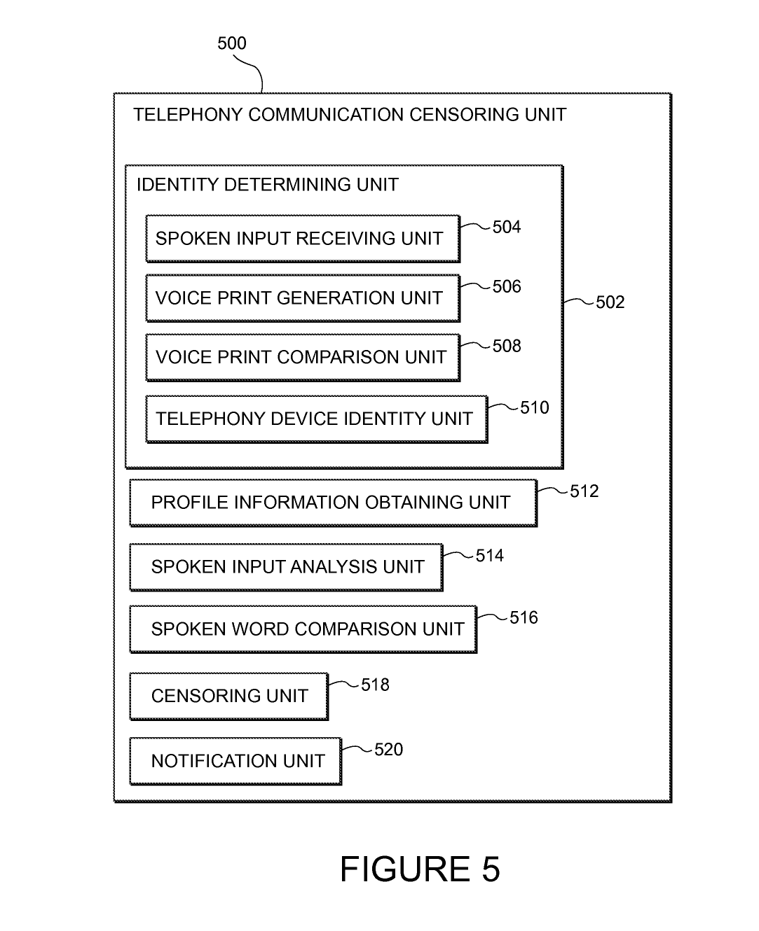

FIG. 5 illustrates elements of one embodiment of a telephony communication censoring unit 500. The telephony communication censoring unit 500 determines when it is necessary to censor all or a portion of a telephony communication to prevent a first party to the telephony communication from providing potentially damaging information to a second party to the telephony communication.

The telephony communication censoring unit 500 includes an identity determining unit 502 that determines an identity of one or more parties to a telephony communication. The identity determining unit 502 includes a spoken input receiving unit 504, a voice print generation unit 506 and a voice print comparison unit 508. These elements work together, as will be explained in detail below, to identify a party to the telephony communication via a voice print analysis.

The identity determining unit 502 also includes a telephony device identity unit 510. The telephony device identity unit 510 determines an identifier that is associated with a telephony device used by a party to a telephony communication. This could be a telephone number assigned to the telephony device. Alternatively, this could be an identification number associated with a telephony device, such as an International Mobile Subscriber Identity (IMSI) number that is assigned to most cellular telephones. The identifier could also be an identifier assigned by an IP telephony system to an IP telephony device or to an IP telephony software application resident on a computing device. In still other instances, the identifier could be an Internet protocol address used by an IP telephony device, or some other identifier. Once the identifier of a telephony device is known, the identity of the party making use of the telephony device is determined or inferred from this information. Details about how the telephony device identification unit 510 operates to obtain a telephony device identifier and then identify the user of the telephony device are provided below.

The telephony communication censoring unit 500 also includes a profile information obtaining unit 512 that obtains profile information for a system user from a profile database 306 of an IP telephony system 300, as illustrated in FIG. 3. The information drawn from the profile database 306 is used to determine when it is necessary to censor all or a portion of a telephony communication, as will be described below.

Also, a spoken input analysis unit 514 obtains spoken input from a party to a telephony communication, and analyzes the spoken input using speech recognition techniques. The result of the analysis is a transcription of portions of the telephony communication. A spoken word comparison unit 516 then compares words in the transcription to keywords drawn from a user's profile in the profile database 306, as obtained by the profile information obtaining unit 512. If words appearing in the transcription match one or more keywords in the user's profile, this can trigger a censoring unit 518 to censor all or a portion of the telephony communication. Censoring a portion of a telephony communication typically means that words spoken by a first party to the communication are not delivered to or played to a second party to the communication. Details regarding how and when censoring takes place are provided below.

The telephony communication censoring unit 500 also includes a notification unit 520 that sends communications to an account administrator under certain conditions. The notification unit 520 can be configured to send communications to the account administrator whenever the censoring unit 518 acted to censor all or a portion of a telephony communication. In alternate embodiments, the notification unit 520 could be configured to only send communications to the account administrator when certain keywords have triggered the censoring unit 518 to censor all or a portion of a telephony communication. The communications can include information about what caused the censoring to occur, and the parties that were involved in the telephony communication that was censored.

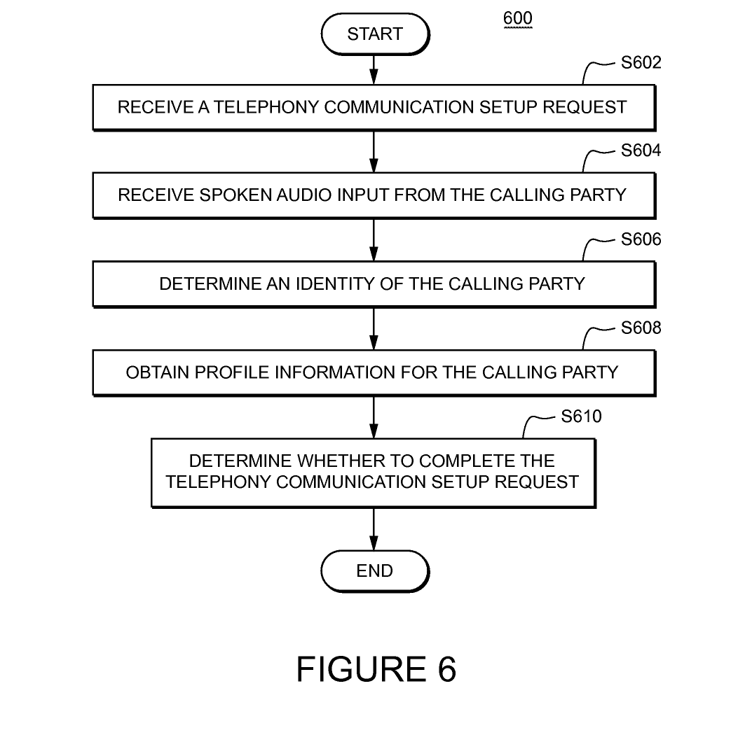

FIG. 6 illustrates steps of a method 600 of that would be performed by a telephony communication setup unit 400 as illustrated in FIG. 4 to determine whether or not to complete a requested telephony communication. This method would be performed when a user of an IP telephony system 300 is requesting the setup of an outgoing telephony communication directed to another user of the IP telephony system or to a party that is reachable via a different telephony system, such as a PSTN or a cellular telephony system.

The method 600 begins and proceeds to step S602, where a setup request handling unit 402 receives a telephony communication setup request from a user of an IP telephony system. In many instances, this could be a request to setup a new telephone call. In other instances this could be a request to setup or send some other type of telephony communication. Although the setup request handling unit 402 likely will know the telephone number associated with the telephony device used to issue the telephony communication setup request, and possibly one or more device identifiers associated with the telephony device, this will not necessarily be indicative of the identity of the party making the telephony communication setup request. In some instances, the telephony device could be one that is present in a residence or business and which is used by multiple different parties. In other instances, the telephony device might be one which is normally used by only a single party, but which is being used by someone other than its regular user. For these reasons, additional steps are taken to determine the identity of the user making the telephony communication setup request.

In step S604, a spoken input receiving unit 406 of an identity determining unit 404 receives spoken input from the user that issued the telephony communication setup request. This could occur by having the user speak a predetermined word or phrase. For example, the spoken input receiving unit 406 could play an audio message to the user asking the user to repeat a predetermined phrase, or possibly the user's name. When the user speaks that predetermined phrase, it is captured by the spoken input receiving unit 406 in step S604. Alternatively, the spoken input receiving unit 406 may simply capture the initial audio portion of a telephony communication as the spoken audio input.

In step S606, the spoken input is used to determine the identity of the user that issued the telephony communication setup request. This could be accomplished by having a voice print generation unit 408 generate a voice print for the user using the spoken input captured in step S604. Next, a voice print comparison unit 410 compares the voice print generated by the voice print generation unit 408 to multiple voice prints stored in a voice print database 308 of an IP telephony system 300. To make this comparison relatively rapid and easy, initially the voice print generated by the voice print generation unit 408 may only be compared to voice prints of users that typically make use of the telephony device that was used to issue the telephony communication setup request. If there is no match, then the voice print could be compared to other voice prints in the voice print database 308. Assuming there is a match to at least one voice print in the voice print database 308, the identity of the user will be known.

In step S608, profile information for the user is obtained from a profile database 306 by a profile information obtaining unit 416. The profile information will provide an indication about whether the user should be prevented from setting up the telephony communication with the party identified in telephony communication setup request. In step S610, the setup request handling unit 402 uses the information in the telephony communication setup request received in step S602, which identifies the party to which the telephony communication is directed, as well as information from the user's profile, as obtained in step S608, to determine whether or not to complete the requested telephony communication.

Also, as mentioned above, if the setup request handling unit 402 makes a tentative decision to refuse to setup a telephony communication, a party to the call may be capable of requesting an account administrator to override that decision. A notification unit 418 of the telephony communication setup unit 400 would send a communication to the account administrator asking the account administrator for permission to setup the telephony communication, and the notification unit 418 would receive input from the account administrator and relay it to the setup request handling unit 402, which would act accordingly.

The information in a user's profile, as recorded in the profile database 306, is entered and controlled by an administrator of an account with the IP telephony system. For example, if an individual is the only user of an account with the IP telephony system, the individual will be the administrator, and the individual will be able to setup and edit his user profile in the profile database 306.

On the other hand, if a particular account with the IP telephony system is for a telephone line/device in a residence, the individual that initially sets up the account could be the administrator. That individual could then setup user profiles for all people living in the residence that might potentially use the line/device. For example, a parent that sets up an account with the IP telephony system could setup user profiles for all family members that live in a residence and that might use the telephony service provided by the IP telephony system to place and receive telephony communications. The user profiles could be setup via a web interface, via an interactive voice response system, via interactions with a customer service agent of the IP telephony system or via other means.

A user profile could indicate that telephony communications directed to certain telephone numbers should be prevented. Alternatively, or in addition, a user profile could indicate that the user is only allowed to setup telephony communications that are directed to a specified list of acceptable telephone numbers. If a user profile is configured in this manner, in step S610, the setup request handling unit 402 compares the telephone number specified in the user's telephony communication setup request to the telephone numbers that are identified as acceptable in the user's profile to determine if the requested telephony communication should be allowed. If so, the setup request handling unit 402 completes the requested telephony communication. If not, the setup request handling unit 402 refuses to complete the requested telephony communication. A refusal could include playing an audio or video message to the user indicating that the telephony communication setup request is being refused because it is not authorized.

In still other instances, a user profile could indicate that the user is to be prevented from setting up telephony communications directed to classes of individuals or to certain types of businesses. For example, a user's profile could indicate that the user is to be prevented from setting up a telephony communication to any food delivery businesses. If that is the case, in step S610 the setup request handling unit 402 uses the telephone number in the telephony communication setup request to perform a directory lookup. If the telephone number is for a food delivery business, the setup request handling unit 402 refuses to complete the requested telephony communication. Otherwise, the telephony communication is setup as requested.

A user's profile could be configured in any number of different ways to indicate what types of telephony communications are acceptable and what types of telephony communications should be prevented. As noted above, this could include providing a list of acceptable telephone numbers, providing a list of unacceptable telephone numbers, or specifying acceptable or unacceptable classes of individuals or businesses. Any other way of defining who a user can and cannot communicate with could also be used.

In the foregoing example, a user is asked to speak a word or a phrase, and a voice print that is generated using the spoken input is utilized to identify the user. In alternate embodiments, the user could be identified via alternate methods. For example, in some instances the user could be prompted to enter an identification code using a keypad of the user's telephony device. The identification code could be used to identify the user in a manner similar to how a voice print is used. Once the user has been identified, the same steps explained above are performed to determine whether or not to complete the requested telephony communication.

A method as explained above, and as illustrated in FIG. 6, could be used to prevent a young child from making an unauthorized telephone call. The same method could be used to prevent other users of the account from making certain toll-bearing telephony communications which the administrator wishes to prevent.

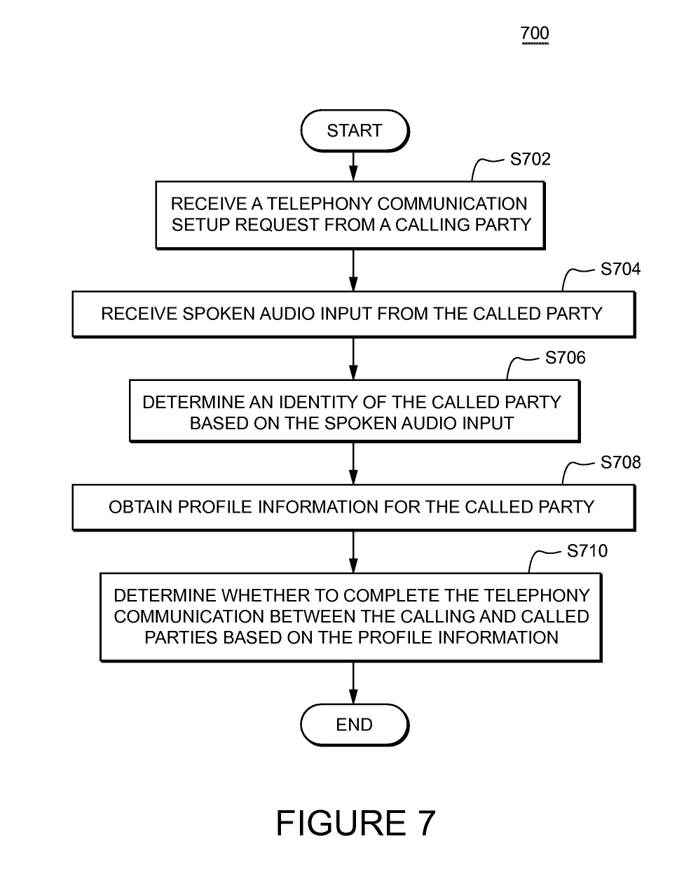

FIG. 7 illustrates steps of a method that is also performed by a telephony communication setup unit 400. However, the method 700 illustrated in FIG. 7 is performed when the IP telephony system receives an incoming telephony communication directed to a user of the IP telephony system. Here again, the incoming telephony communication could be directed to a telephone number or an identifier of a line or telephone device that is utilized by multiple different individuals, such as members of a family who live in a residence that has telephony service provided by the IP telephony system. Thus, in the case of a telephone call, when the IP telephony system is preparing to complete the call to a telephony device associated with the called telephone number, the IP telephony system will not initially know who is answering the call.

The method 700 starts and proceeds to step S702 where a setup request handling unit 402 receives a telephony communication setup request that is directed to a telephone number or identifier associated with a user or account with the IP telephony system. The setup request handling unit 402 sends setup signaling to a telephony device associated with the dialed telephone number (or other identifier) in the received telephony communication setup request, and this causes the telephony device to ring or otherwise provide an indication that there is an incoming communication. Assuming an individual answers, in step S704, a spoken input receiving unit 406 asks the answering party to provide spoken input. Here again, this could include playing a recorded audio or video message to the user that asks the user to speak a word or phrase, such as the user's name. The spoken input receiving unit 406 then records the spoken input provided by the answering party in response to that message. As also mentioned above, in alternate embodiments, the user could be asked to input an identification code or some other identifier using a keypad of the telephony device. In yet other alternative embodiments, the spoken input receiving unit 406 may simply capture the initial audio portion of a telephony communication and use that as the spoken audio input.

In step S706, the spoken input is used to identify the individual that answered the incoming telephony communication. In some embodiments, this is accomplished by a voice print generation unit 408 creating a voice print using the spoken input received in step S704. A voice print comparison unit then compares the generated voice print to voice prints in a voice print database 308 of the IP telephony system. The generated voice print initially may only be compared to a limited number of voice prints corresponding to the users who routinely make use of the telephony device used to answer the incoming telephony communication. If this does not provide a match, the generated voice print is compared to other voice prints in the voice print database 308. Assuming there is a match, the individual that answered the incoming telephony communication is identified.

In alternate embodiments, a party's identity could be determined via alternate means. For example, a party may be asked to input an identification code. Also, caller ID information could be used to help identify a party to a communication. Also, some telephony device may include sensors, such as fingerprint sensors, which could be used to identify a party to a telephony communication. Thus, the telephony device itself may perform all or a portion of the identification function, and then send that information on to the IP telephony system. Alternatively, a sensor, such as a fingerprint sensor or a retinal scanner, could obtain data relating to a user's physiology, and this information could be forwarded to the IP telephony system. The IP telephony system would then use this information to identify the user.

In step S708, a profile information obtaining unit 416 obtains information from a profile that is maintained for the identified user in a profile database 306. As in the methods described above, the profile information could include information that indicates with whom the user is authorized to communicate. For example, the information in the user's profile could include a list of telephone numbers from whom the user can receive an incoming telephony communication. Alternatively, the information in the user's profile could specify the telephone numbers from which the user cannot receive an incoming telephony communication. The information in the user's profile could also indicate classes of individuals or businesses with whom the user is authorized to communicate or with whom the user is not authorized to communicate.

In step S710, the setup request handling unit 402 uses the information obtained from the user's profile, and information in the incoming telephony communication setup request, such as the telephone number or identity of the calling party, to determine whether or not to allow the user to begin communicating with the calling party. If the user's profile information indicates that the user is to be prevented from communicating with a class of individuals or a certain type of business, then the decision made in step S710 may require that the setup requesting handling unit 402 determine whether the calling party falls within that class of individuals or businesses. And this may require that the setup request handling unit utilize a calling telephone number provided in caller ID information, along with a directory service to determine the identity of the calling party.

A method as illustrated in FIG. 7 can be used to control who is allowed to receive and conduct an incoming telephony communication. For example, an administrator of an account with the IP telephony system could configure the user profiles of individuals who typically utilize the account to control who the individuals are allowed to communicate with. A parent could configure the profiles of children that make use of a telephone line or telephony device to state that the children cannot receive incoming telephony communications from telemarketers or businesses that solicit information. Alternatively, the administrator could configure the user profiles of children to allow the children to receive incoming telephony communications only from a defined group of telephone numbers and/or from a defined group of trusted individuals.

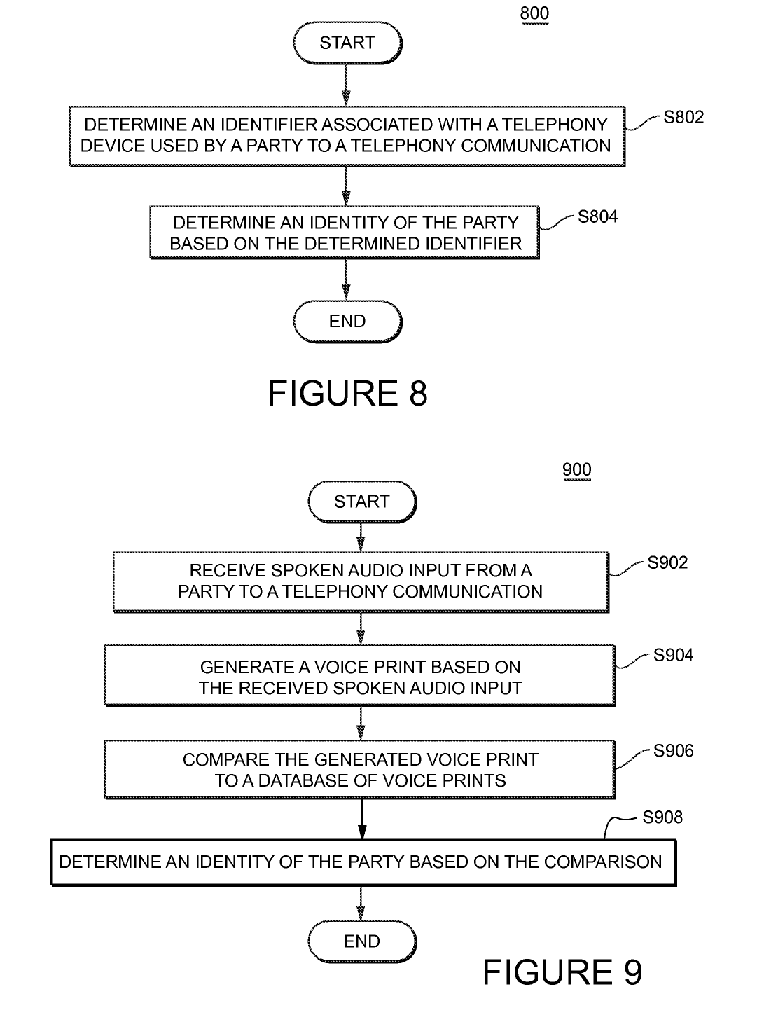

FIG. 8 illustrates steps of a method that could be performed to determine an identity of a party to a telephony communication. The party being identified could be a party initiating an outgoing telephony communication, or a party receiving an incoming telephony communication. The method 800 begins and proceeds to step S802 where an identifier associated with the telephony device used by a party to the telephony communication is determined. The identifier could be a telephone number associated with the telephony device, or some other identifier. In step S804, the identity of the party is determined using the identifier.

For example, if the identifier is a telephone number associated with a telephony device, a directory service or some other database could be used to determine an identity of a party associated with that telephone number. However, the identity of the party need not be an individual's name. Instead, if the identifier is for a business, the identity of the party could be the business identity.

A method as illustrated in FIG. 8 could be used by a setup request handling unit 402 to determine an identity of a calling party that has requested that a telephony communication be established to a user of an IP telephony system. Thus, a method as illustrated in FIG. 8 could form part of the actions performed in step S710 of the method illustrated in FIG. 7 when the setup request handling unit needs to determine if an incoming telephony communication is to be completed to a user.

In alternate embodiments, the identity of a party to a telephony communication, such as the calling party, could be established in different ways. For example, FIG. 9 illustrates steps of a method of using a voice print analysis to determine the identity of party. The method 900 begins and proceeds to step S902 where spoken input is received from a party to a telephony communication. In step S904 a voice print is generated from the received spoken input. In step S906, the generated voice print is compared to voice prints stored in a database of voice prints to see if there is a match. If there is a match, in step S908 the individual that provided the spoken input is determined using information from the database.

A method as illustrated in FIG. 9 could be used to determine the identity of a calling party that is attempting to setup a telephony communication to a user of the IP telephony system. Thus, the method illustrated in FIG. 9 could be used as part of the actions performed in step S710 of the method illustrated in FIG. 7. And once the identity of the calling party is determined, this information could be used, along with information from a profile of the individual that answered the incoming telephony communication, to determine if the individual that answered is authorized to communicate with the party that initiated the telephony communication. Thus, voice print analyses could be used to identify both the calling party and the called party.

The above methods are designed to determine whether a user of an IP telephony system should be allowed to setup an outgoing telephony communication to a particular party, and/or to determine if a user is allowed to receive an incoming telephony communication originating from a particular party. However, there is no guarantee that the methods will be foolproof in preventing a user from speaking with a party that may try to solicit potentially damaging information from the user. Similarly, the methods may not be foolproof in preventing a user from speaking to unauthorized individuals. Thus, it may be desirable, under certain circumstances, to electronically monitor a telephony communication to ensure that a user is not disseminating potentially harmful information, and to ensure the user is not requesting goods and/or services from an unauthorized party.

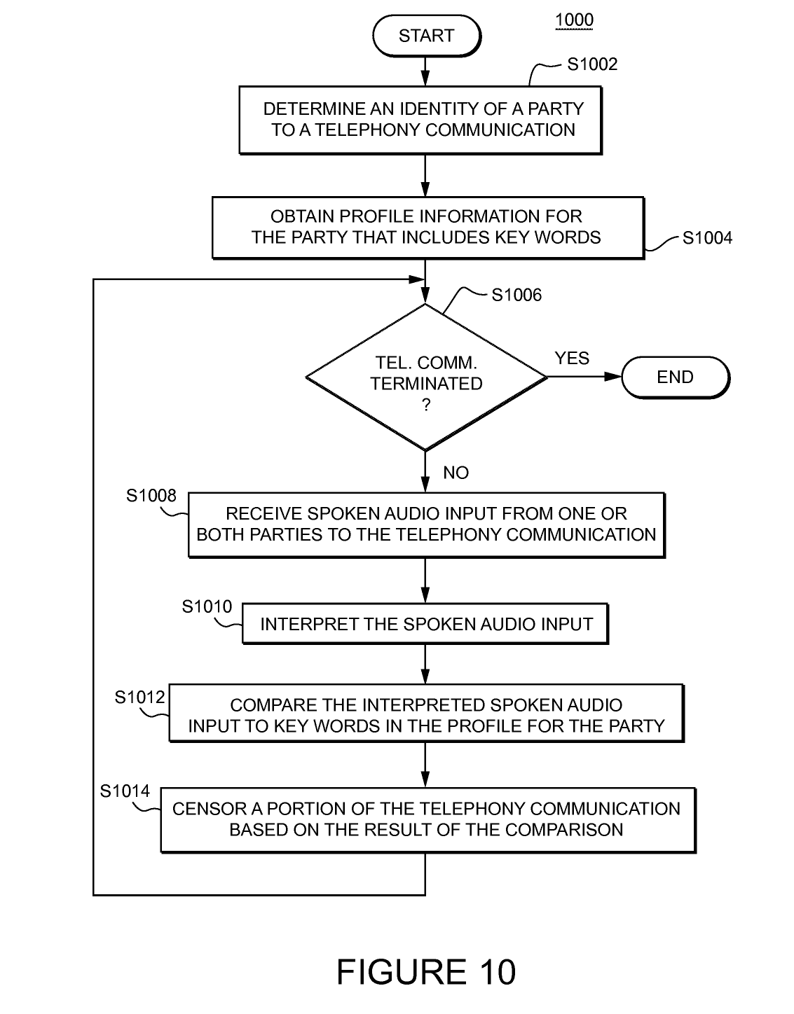

FIG. 10 illustrates steps of a method of electronically monitoring a telephony communication, and for selectively censoring the communication or automatically terminating the communication. Certain steps of such a method could be performed by a telephony communication censoring unit 500 as illustrated in FIG. 5.

The method 1000 begins and proceeds to step S1002 where an identity of a party to a telephony communication is determined. The party would be a user of the IP telephony system that is associated with an account of the IP telephony system. In some instances, this would be a user that initiated an outgoing telephony communication using the IP telephony system. In other instances, this would be a user of the IP telephony system that received an incoming telephony communication via the IP telephony system.

The identity of the user is determined by an identity determining unit 502 of the telephony communication censoring unit 500. Similar to the methods described above, and as illustrated in FIG. 9, in some embodiments a spoken input receiving unit 504 obtains spoken input from the user, and a voice print generation unit 506 generates a voice print using the spoken input. A voice print comparison unit 508 then compares the generated voice print to voice prints in a voice print database to identify the user. Alternatively, and as illustrated in FIG. 8, a telephony device identity unit 510 could obtain an identifier associated with a telephony device that the user is operating to conduct the telephony communication, and the identifier could be used to identify the user.

Next, in step S1004, a profile information obtaining unit 512 obtains profile information for the identified user from a profile database. The profile information includes keywords that may be used to trigger the censoring or early termination of the telephony communication. The method then proceeds to step S1006 where a check is performed to determine if the telephony communication has been terminated by either party. If so, the method ends. If not, the method proceeds to step S1008.

In step S1008, spoken input is received by a spoken input analysis unit 514 of the telephony communication censoring unit 500. The spoken input can be received from the user, or from the other party to the telephony communication, or from both parties to the communication. The inventors presently contemplate that spoken input will be received for a predetermined period of time, and that the received spoken input will then be interpreted in step S1010. In step S1010, the spoken input analysis unit 514 utilizes speech to text techniques to create a transcript of the received spoken input.

The spoken input analysis unit 514 may perform various functions at the beginning of a telephony communication to maximize the likelihood that the received spoken input will be properly transcribed in step S1010. For example, profile information obtained in step S1004 may indicate the language or languages spoken by the user, which would help the spoken input analysis unit 514 to determine how to transcribe the spoken input. Alternatively, the spoken input analysis unit 514 may perform a function or procedure on the spoken audio input that is received at the beginning of the telephony communication to determine the language being spoken by the parties to the telephony communication. Other information in the user's profile may also be used to help fine tune the speech-to-text transcription of the received spoken audio input.

In addition, to accurately perform a speech-to-text transcription, it is sometimes helpful to use the audio from a second, subsequent portion of a conversation to properly interpret a first, preceding portion of the conversation. For this reason, the spoken audio input obtained in step S1008 may be for ten seconds, but only the first five seconds of the captured audio is transcribed, using the second five seconds to provide context, The second five seconds of captured spoken audio input is then transcribed using the next five seconds of the conversation, and so on. Of course, the time periods mentioned above are only exemplary. Other time periods could also be used.

In step S1012, a spoken word comparison unit 516 compares the words in the transcription prepared in step S1010 to one or more keywords in the user's profile obtained in step S1004. If there is a match, then in step S1014, a portion of the telephony communication may be selectively censored by a censoring unit 518. Censoring a portion of the telephony communication would typically involve preventing something spoken by one party to the communication from being heard by the other party to the telephony communication.

For example, if the user is a young child, an administrator of the account used by the child could configure the child's profile to include keywords such as the user's address, name, social security number, credit card numbers, and other key personal information that could be damaging if obtained by a party wishing to do harm. If the spoken word comparison unit 516 determines that the user is attempting to convey this information to the other party to the conversation, the censoring unit 518 prevents the other party from hearing what the user said.

In another example, the keywords could include words that would be spoken by the other party to the conversation in an attempt to elicit potentially damaging information from the user. Thus, for example, the key words could be words and phrases such as “address,” “social security,” or “credit card.” If a transcript of a portion of a telephony communication includes these words, as spoken by the other party, the censoring unit 518 either prevents the user from hearing a question that includes these keywords, or the censoring unit 518 prevents the other party from hearing any response that the user gives to these words, or both.

In still other embodiments, if certain keywords are noted in a transcript of a portion of a telephony communication, the presence of such a keyword could cause the censoring unit 518 to terminate the telephony communication.

A user profile could include some keywords that only result in a portion of the telephony communication bring censored or blocked, and other keywords that result in early termination of the telephony communication.

Once an analysis of a portion of spoken audio input is accomplished in steps 1010-1014, the method then loops back to step 1006, and the above process is repeated until one of the parties terminates the telephony communication, or until the presence of a keyword(s) in a transcript of a portion of the telephony communication triggers the censoring unit to terminate the telephony communication in step S1014.

In many of the methods described above, a voice print from a user is compared to voice prints in a voice print database. If a user tends to use more than one telephony device to access telephony communication services from the IP telephony system, separate voice prints for the user obtained from each of those telephony devices could be stored in the voice print database. Obtaining multiple voice prints for a user, each one being created using audio generated by a different telephony device, could lead to more accurate identification of the user.

Also, the voice prints in the voice print database could be fine tuned over time as the IP telephony system obtains additional spoken input from a user. Here again, the aim of fine tuning the voice prints would be to more accurately identify the user.

In many of the methods described above, elements of the IP telephony system, such as the telephony communication setup unit 400 and the telephony communication censoring unit 500, take actions to control how a user makes use of the IP telephony system. For example, a user may be prevented from completing a requested outgoing telephony communication, or an incoming telephony communication may not be completed to a user. Alternatively, portions of a telephony communication may be censored, or a telephony communication may be terminated if a keyword appears in the telephony communication. Any time that such actions occur, a notification may be sent to an administrator or some other designated individual connected with the account that was being used when the action occurred. Such notifications could be sent to the administrator or designated individual via e-mail, via text message, via a voice message, or via some other means. The notification could specify in detail the action that was taken and the reasons why the action was taken.

As noted above, it is possible for a telemarketer to periodically change the telephone number and/or name that is shown to a called party as part of caller ID information in an attempt to prevent automatic screening systems from identifying and blocking calls from the telemarketer. However, when a telephone number and/or name for the telemarketer is identified, it can be rapidly added to a list that is available to interested parties. The user profile information that is stored for users and which is used to define who a user can communicate with can be tied to such lists. As a result, it is not necessary for an administrator of an account to continuously update user profiles to include telephone numbers that should be blocked. Instead, an administrator could simply specify that all telephone numbers on a list of known telemarketers maintained by the IP telephony system, or some other party, be used along with other information to block calls to a particular user.

If a calling party that uses a different telephony system sends a telephony communication setup request to an IP telephony system operating as described above, and the telephony communication setup request asks for a telephony communication to be setup to a user of the IP telephony system, the IP telephony system might not have a voice print for the calling party. As a result, the IP telephony system normally is only able to identify the calling party using an identifier associated with the calling party's telephony device. If the user is a young child that has profile information indicating that only calls from certain telephone numbers are to be completed to the user, this could prevent a known authorized individual from completing a call to the user if the authorized individual is calling from an alternate telephony device.

Under these circumstances, the IP telephony system could pre-record a voice print from the authorized individual, and the user's profile information would indicate that calls from that authorized individual are to be completed to the user, regardless of what telephony device the authorized user happens to use to make a call to the user. The IP telephony system is then able to identify the authorized individual using a voice print analysis, even through the authorized user is not a customer of the IP telephony system. Similarly, the authorized user could be given an override code that allows the authorized user to complete a call to the user, regardless of what telephony device the authorized user utilizes to place a call to the user.

In certain embodiments, some of the actions performed by a telephony communication setup unit 400 as illustrated in FIG. 4 may be performed by servers or other elements of an IP telephony system, and other actions may be performed by a user's telephony device. Likewise, in certain embodiments, some of the actions performed by a telephony communication censoring unit 500 as illustrated in FIG. 5 may be performed by servers or other elements of an IP telephony system, and other actions may be performed by a user's telephony device.

In many of the systems and methods described above, spoken audio input from one or both parties to a telephony communication is used to identify a party, to determine if a portion of a telephony communication should be censored, and to determine if a telephony communication should be terminated. This requires that certain elements be able to capture the spoken audio input. This could be accomplished by having elements of the telephony communication setup unit 400 and the telephony communication censoring unit 500 intercept or copy the audio traversing a user's telephony device, or an element of the IP telephony system responsible for carrying the media of a telephony communication between two telephony devices. For example, all or a portion of the media passing back and forth between two telephony devices via a media relay could be intercepted at the media relay.

In the foregoing example embodiments, an IP telephony system is used to complete calls to and from a user. Elements of the IP telephony system determine whether to complete an outgoing call for the user or whether to complete an incoming call to the user based on an identity of the calling or called party, and based on profile information for the user. Likewise, elements of the IP telephony system determine whether a portion of a telephony communication for a user should be censored, and whether a telephony communication for a user of the IP telephony system should be automatically terminated. The use of an IP telephony system is merely exemplary. The telephony system involved in taking these actions need not be an IP telephony system. Any sort of telephony system could also perform these functions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of determining whether to complete a telephony communication, comprising:
receiving a telephony communication setup request from a calling party;
receiving spoken audio input from the calling party;
determining an identity of the calling party based on the received spoken audio input;
obtaining profile information for the calling party based on the determined identity of the calling party; and
determining whether to complete the requested telephony communication based on the obtained profile information for the calling party.

2. The method of claim 1, wherein the step of determining whether to complete the requested telephony communication is also based on an identity of a called party to which the telephony communication is directed.

3. The method of claim 2, further comprising determining an identity of the called party based on an identifier contained in the telephony communication setup request.

4. The method of claim 2, further comprising:
receiving spoken audio input from the called party;
generating a voice print based on the spoken audio input received from the called party; and
comparing the voice print generated based on the spoken audio input received from the called party to a database of voice prints; and
determining the identity of the called party based on the comparison.

5. The method of claim 1, wherein determining an identity of the calling party comprises:
generating a voice print based on the received spoken audio input;
comparing the generated voice print to a database of voice prints;
determining an identity of the calling party based on the comparison.

6. The method of claim 5, further comprising determining an identifier associated with a telephony device used by the calling party to provide the received spoken audio input, and wherein the comparing step comprises comparing the generated voice print to each of a plurality of voice prints associated with the telephony device.

7. A system for determining whether to complete a telephony communication, comprising:
means for receiving a telephony communication setup request from a calling party;
means for receiving spoken audio input from the calling party;
means for determining an identity of the calling party based on the received spoken audio input;
means for obtaining profile information for the calling party based on the determined identity of the calling party; and
means for determining whether to complete the requested telephony communication based on the obtained profile information for the calling party.

8. A system for determining whether to complete a telephony communication, comprising:
a setup request handling unit that receives a telephony communication setup request from a calling party;
an identity determining unit that receives spoken input from the calling party and that determines an identity of the calling party based on the received spoken audio input;
a profile information obtaining unit that obtains profile information for the calling party based on the determined identity of the calling party, wherein the setup request handling unit determines whether to complete the requested telephony communication based on the obtained profile information for the calling party.

9. The system of claim 8, wherein the setup request handling unit also determines whether to complete the requested telephony communication based on an identity of a called party to which the telephony communication is directed.

10. The system of claim 9, wherein the setup request handling unit determines an identity of the called party based on an identifier contained in the telephony communication setup request.

11. The system of claim 9, wherein the identity determining unit comprises:
a spoken input receiving unit that receives spoken audio input from the called party;
a voice print generation unit that generates a voice print based on the spoken audio input received from the called party; and
a voice print comparison unit that compares the voice print generated by the voice print generation unit to a database of voice prints and that determines the identity of the called party based on the comparison.

12. The system of claim 8, wherein the identity determining unit comprises:
a voice print generation unit that generates a voice print based on the spoken audio input received from the calling party; and
a voice print comparison unit that compares the generated voice print to a database of voice prints and that determines an identity of the calling party based on the comparison.

13. The system of claim 12, further comprising a telephony device identity unit that determines an identifier associated with a telephony device used by the calling party to provide the received spoken audio input, and wherein the voice print comparison unit compares the generated voice print to each of a plurality of voice prints associated with the telephony device.

14. A method of determining whether to complete a telephony communication, comprising:
receiving a telephony communication setup request from a calling party requesting that a telephony communication be completed to a called party;
receiving spoken audio input from the called party;
determining an identity of the called party based on the received spoken audio input;
obtaining profile information for the called party based on the determined identity of the called party; and
determining whether to complete the requested telephony communication based on the obtained profile information for the called party.

15. The method of claim 14, further comprising:
determining an identifier associated with a telephony device used by the calling party; and
determining an identity of the calling party based on the identifier, wherein the step of determining whether to complete the requested telephony communication is also based on the determined identity of the calling party.

16. The method of claim 14, further comprising:
receiving spoken audio input from the calling party;
determining an identity of the calling party based on the spoken audio input received from the calling party, and wherein the step of determining whether to complete the requested telephony communication is also based on the determined identity of the calling party.

17. The method of claim 16, wherein the step of determining an identity of the calling party comprises:
interpreting the spoken audio input received from the calling party using speech recognition techniques; and
determining the identity of the calling party based on the interpretation of the received spoken audio input.

18. The method of claim 17, wherein the step of determining an identity of the calling party comprises:
receiving spoken audio input from the calling party;
generating a voice print based on the spoken audio input received from the calling party;
comparing the voice print generated based on the spoken audio input received from the calling party to a database of voice prints; and.
determining an identity of the calling party based on the comparison.

19. The method of claim 14, wherein determining an identity of the called party comprises:
generating a voice print based on the spoken audio input received from the called party; and
comparing the generated voice print to a database of voice prints; and
determining an identity of the called party based on the comparison.

20. The method of claim 19, further comprising determining an identifier associated with a telephony device used by the called party to provide the received spoken audio input, and wherein the comparing step comprises comparing the generated voice print to each of a plurality of voice prints associated with the telephony device.
